(19) United States
(12) Patent Application Publication
(10) Pub. No.: US 2007/0181740 A1
(43) Pub. Date: Aug. 9, 2007

(54) Tape reel and method for manufacturing the same

(75) Inventor: Teruo Sogabe, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/656,485

(22) Filed: Jan. 23, 2007

(30) Foreign Application Priority Data
Jan. 24, 2006 (JP) 2006-015527

(51) Int. Cl. G11B 23/037

(52) U.S. Cl. 242/608.8

(57) ABSTRACT

A tape reel according to the present invention includes: a disk-shaped first flange; a cylindrical hub; and a disk-shaped second flange. The first flange and the second flange extend in a radial direction from an outer periphery of the hub. At least one flange selected from the first flange and the second flange is joined to the hub at a joint portion. At least in the joint portion, the flange and the hub are formed of different materials, and the different materials are an infrared absorbing material and an infrared transmitting material.

### BACKGROUND OF THE INVENTION

1. Field of the Invention

The present invention relates to a tape reel that achieves high accuracy and a method for manufacturing the same.

2. Description of Related Art

In recent years, means for high-speed information transmission such as optical fibers have made remarkable progress. As a result, it became possible to transmit images and data with an enormous amount of information, while at the same time, there arises an increasing demand for advanced techniques to record, reproduce, and store such images and data. Examples of recording and reproducing media include flexible disks, magnetic drums, hard disks, and magnetic tapes. Tape-shaped recording media such as magnetic tapes play a major role mainly as data backup media, because their recording capacity per reel is large.

Examples of the tape-shaped recording media include magnetic tapes and optical tapes. Usually, the tape-shaped recording medium is used in the state where it is wound around a reel and housed in a cartridge. The reel falls into two types, namely, a two-piece type and a three-piece type. As shown in FIG. 15, a two-piece type reel 200 includes: a hub 202 (a magnetic tape, for example, can be wound around an outer peripheral surface 201 of this hub 202); a disk-shape first flange 203 that has an opening in its center and is fixed to the hub 202 by welding; and a disk-shaped second flange 204 that is formed integrally with the hub 202. The first flange 203 can be joined to the hub 202 by ultrasonic welding, caulking, or the like (see JP 10(1998)-320958 A, JP 8(1996)-147929 A, and JP 2001-243739 A, for example). Furthermore, as shown in FIG. 16, when the reel 200 is in use, a magnetic tape 205 is wound around the outer peripheral surface 201 of the hub 202. As shown in FIGS. 17A and 17B, the hub 202 as a component of the two-piece type reel is formed integrally with the second flange 204, and the second flange 204 is formed so as to extend in the radial direction from an outer periphery of the hub 202.

On the other hand, a three-piece type reel corresponds to, for example, the above-described two-piece type reel 200 in which the hub 202 and the second flange 204 are provided as separate components. In the three-piece type reel, the first flange, the hub, and the second flange can be joined to each other by snap-fitting or the like (see JP 2002-298542 A, for example)

In both the two-piece type reel and the three-piece type reel, the components thereof generally are manufactured by injection molding of a resin. In the two-piece type reel, the first flange and the hub provided with the second flange are manufactured separately by injection molding. On the other hand, in the three-piece type reel, the first flange, the hub, and the second flange are manufactured separately by injection molding.

Lately, with an increase in recording capacity of a tape cartridge, further improvement in shape accuracy and rotational accuracy of a reel of the tape cartridge has been demanded. However, when the hub and the flange are joined by ultrasonic welding, vibration energy generated by a welding horn is transferred to portions other than a portion that is intended to be welded. As a result, a problem arises that, in the flange etc. having a shape like a thin plate, residual stress stored during the injection molding is activated, resulting in increased warping of the flange etc. Moreover, in the process of welding the hub and the flange, it is necessary to press the first flange 203 against the hub 202 while melting a joining rib 203a, as shown in FIG. 18. Thus, the first flange 203 moves slightly to the hub 202 side at the time of welding. This, however, arises a problem in that, since the positional accuracy control during the movement of the first flange 203 is difficult, the shape accuracy after the welding is deteriorated.

On the other hand, when the flange is joined by caulking, it is necessary that a caulking hole has a minimum clearance. This makes it difficult to realize fine positional accuracy, resulting in deteriorated shape accuracy after the welding. Furthermore, when the age is joined by snap-fitting, the components cannot be fixed to each other completely, which poses a problem in that the components cannot be fixed sufficiently after they have been joined, resulting in the deteriorated shape accuracy of the reel as a whole.

In the case where the conventional flange and hub shown in FIGS. 15 to 18 are joined by laser welding, the following problem occurs. That is, when the joining rib 203a is irradiated with a laser beam in the state before welding as shown in FIG. 18, the laser starts to melt the joining rib 203a from a certain position and continues to melt the joining rib 203a sequentially while moving along the circumference of the concentric circle, thereby welding the first flange 203 and the hub 202 to each other. In this case, the welding is performed in the state where a melted portion and an unmelted portion are present together. Thus, when the first flange 203 moves slightly to the hub 202 side during the welding as described above, the position (the height and the inclination) of the first flange 203 becomes unstable, resulting in deteriorated welding accuracy.

When the shape accuracy of the reel is not sufficient as described above, the rotational accuracy of the reel also is deteriorated to make the tape run unstable. This deteriorates the reading accuracy and recording accuracy of recording signals by the drive head, thereby causing errors in reading and recording the recording signals.

### SUMMARY OF THE INVENTION

The present invention is intended to solve the above-described problems and to provide a tape reel that is improved in shape accuracy of the reel as a whole and a method for manufacturing such a tape reel efficiently.

A tape reel according to the present invention includes: a disk-shaped first flange; a cylindrical hub; and a disk-shaped second flange. The first flange and the second flange extend in a radial direction from an outer periphery of the hub. At least one flange selected from the first flange and the second flange is joined to the hub at a joint portion. At least in the joint portion, the flange and the hub are formed of different materials, and the different materials are an infrared absorbing material and an infrared transmitting material.

A method for manufacturing a tape reel according to the present invention includes: a disk-shaped first flange; a cylindrical hub; and a disk-shaped second flange, the first flange and the second flange extending in a radial direction from an outer periphery of the hub, wherein at least one flange selected from the first flange and the second flange is joined to the hub at a joint portion, at least in the joint portion, the flange and the hub are formed of different materials, and the different materials are an infrared absorbing material and an infrared transmitting material. The method includes the step of: joining the at least one flange selected from the first flange and the second flange to the hub by laser welding.

Since the tape reel according to the present invention can achieve high shape accuracy, the rotational accuracy of the reel also is improved, which allows the running stability of the tape to be improved.

Moreover, by the method for manufacturing a tape reel according to the present invention, the above-described tape reel of the present invention can be manufactured efficiently with simple facilities.

### BRIEF DESCRIPTION OF THE DRAWINGS

FIG. 1A is a plan view showing an example of a first flange used in a tape reel according to the present invention, and FIG. 1B is a sectional view taken along a line I-I in FIG. 1A.

FIG. 2A is a plan view showing an example of a hub used in a tape reel according to the present invention, and FIG. 2B is a sectional view showing main portions of the hub, which is taken along a line II-II in FIG. 2A.

FIG. 3A is a sectional view showing main portions of an example of a tape reel according to the present invention, and FIG. 3B is an enlarged view of a portion 3B in FIG. 3A.

FIG. 4 is a sectional view showing main portions of a tape reel for illustrating an example of a method for manufacturing a tape reel according to the present invention.

FIG. 5 is a sectional view showing main portions of another example of a tape reel according to the present invention.

FIG. 6A is a sectional view showing main portions of still another example of a tape reel according to the present invention, and FIG. 6B is an enlarged view of a portion 6B in FIG. 6A

FIG. 7A is a sectional view showing main portions of still another example of a tape reel according to the present invention, and FIG. 7B is an enlarged view of a portion 7B in FIG. 7A.

FIG. 8A is a sectional view showing main portions of still another example of a tape reel according to the present invention, and FIG. 8B is an enlarged view of a portion 8B in FIG. 8A

FIG. 9A is a sectional view showing main portions of still another example of a tape reel according to the present invention, and FIG. 9B is an enlarged view of a portion 8B in FIG. 9A.

FIG. 10A is a sectional view showing main portions of still another example of a tape reel according to the present invention, and FIG. 10B is an enlarged view of a portion 10B in FIG. 10A.

FIG. 11A is a sectional view showing main portions of still another example of a tape reel according to the present invention, and FIG. 11B is an enlarged view of a portion 11B in FIG. 11A.

FIG. 12A is a sectional view showing main portions of still another example of a tape reel according to the present invention, and FIG. 12B is an enlarged view of a portion 12B in FIG. 12A.

FIG. 13A is a sectional view showing main portions of still another example of a tape reel according to the present invention, and FIG. 13B is an enlarged view of a portion 13B in FIG. 13A.

FIG. 14 is a plan view showing a hub used in still another example of a tape reel according to the present invention.

FIG. 15 is a sectional view showing a conventional tape reel for a magnetic tape.

FIG. 16 is a sectional view showing the state where a tape is wound around the tape reel shown in FIG. 15.

FIG. 17A is a plan view showing a hub used in the conventional tape reel for a magnetic tape, and FIG. 17B is a side view of the same.

FIG. 18 is a sectional view showing main portions of the conventional tape reel for a magnetic tape before and after welding.

### DETAILED DESCRIPTION OF THE INVENTION

The tape reel according to the present invention includes a disk-shaped first flange, a cylindrical hub, and a disk-shaped second flange. The first flange and the second flange extend in a radial direction from an outer periphery of the hub. The tape reel according to the present invention is not limited to a two-piece type tape reel, and can be a three-piece type tape reel. By configuring the tape reel so as to be of three-piece type, the shape accuracies of the respective components can be improved further.

Furthermore, in the tape reel according to the present invention, at least one flange selected from the first flange and the second flange is joined to the hub at a joint portion. At least in this joint portion, the flange and the hub are formed of different materials, and the different materials are an infrared absorbing material and an infrared transmitting material. When the joint portion of the flange and the hub is composed of an infrared absorbing material and an infrared transmitting material, the joining can be achieved by laser welding. Thus, as will be described later, it becomes possible to prevent energy from being transferred to portions other than a portion to be welded and also to join the flange and the hub without applying an external force thereto. This allows the flange to be joined to the hub with high accuracy. As a result, the shape accuracy of the reel is improved and the rotational accuracy of the reel also is improved, which allow the running stability of a tape to be improved.

Preferably, the infrared absorbing material has an infrared transmittance of 10% or less and the infrared transmitting material has an infrared transmittance of 40% or more. With this configuration, the laser welding can be performed efficiently. The term “infrared transmittance” as used herein refers to a light transmittance measured when a 2 mm thick member is irradiated with near infrared radiation having a wavelength of 1064 nm.

It is preferable that, in the joint portion, at least one of a joined surface of the flange and a joined surface of the hub has a surface roughness Rz (ten-point average roughness) of 3 to 40 μm, more preferably 10 to 40 μm. This allows the joining strength at the joint portion to be improved further.

It is preferable that a shortest distance between the joined surfaces in the joint portion and a tape-winding surface of the hub is 0.5 mm or more. With this configuration, it is possible to suppress the transfer of the heat caused during the laser welding to the tape-winding surface, thus preventing the thermal deformation of the tape-winding surface.

It is preferable that the joined surfaces in the joint portion are inclined with respect to a principal plane of the flange to an inner peripheral side. With this configuration, the positioning accuracy of the flange and the hub can be improved. Note here that, when surfaces to be joined are inclined surfaces, it is difficult to join these surfaces by conventional ultrasonic welding because a portion to be melted cannot be targeted by the conventional ultrasonic welding. However, according to laser welding, the inclined surfaces can be joined reliably.

It is particularly preferable that an angle that the joined surfaces in the joint portion form with the principal plane of the flange on the inner peripheral side is 45°. With this configuration, it is possible to improve the positioning accuracy of the flange in both the thickness direction and the radial direction.

Each of the joined surfaces in the joint portion may include a portion inclined with respect to the principal plane of the flange, a portion perpendicular to the principal plane of the flange, and a portion parallel to the principal plane of the age. With this configuration, the positioning accuracy of the first flange and the hub can be improved further, and besides, since the welded area increases, the joining strength can be improved further.

In the joint portion, a projection may be formed on at least one of a joined surface of the flange and a joined surface of the hub With this configuration, the positioning accuracy of the flange in the radial direction can be improved further, and besides, since the welded area increases, the joining strength can be improved further.

The joined surfaces in the joint portion may be formed of curved surfaces. With this configuration, the welded area increases, so that the joining strength can be improved further.

Furthermore, a space may be formed between the joined surfaces in the joint portion and the tape-winding surface of the hub. With this configuration, it is possible to suppress the transfer of the heat caused during the laser welding to a tape-winding surface more reliably, and the influence of heat expansion/shrinkage during the laser welding can be absorbed. Thus, the shape accuracy of the tape-winding surface can be maintained.

The tape reel according to the present invention is applicable not only to a single-reel type tape cartridge but also to a double-reel type tape cartridge. Moreover, the tape reel according to the present invention can be used not only as a reel of a tape cartridge but also as a reel of a drive.

On the other hand, a method for manufacturing the tape reel according to the present invention includes the step of joining the at least one age selected from the first flange and the second flange to the hub by laser welding. When the flange is joined to the hub by laser welding, a laser beam can be focused on a predetermined joint portion, so that it is possible to melt only predetermined surfaces to be joined (an interface between portions to be welded). Also, it is possible to prevent energy from being transferred to portions other than a portion to be welded, thus preventing the warping and deformation of the flange etc. Moreover, since the flange, which is prone to be deformed, can be joined without applying an external force, it is possible to improve the joining accuracy Therefore, the shape accuracy of the reel can be improved and the rotational accuracy of the reel also is improved, which allow the running stability of a tape to be improved.

A laser beam used for the laser welding preferably is near-infrared radiation having a wavelength in a range from 700 to 1100 nm, more preferably from 750 to 1064 nm. This is because resin materials, which are most commonly used as the material of a reel, can absorb near-infrared radiation having a wavelength within this range easily, so that the welding at the joint portion can be performed easily.

It is preferable that a thickness of the infrared transmitting material in a laser beam irradiation direction is 4 mm or less. With this configuration, it is possible to improve the laser transmittance.

Hereinafter, the present invention will be described by way of illustrative embodiments with reference to the drawings Although the following embodiments are directed to the case where the present invention is applied to a two-piece type reel, the present invention also is applicable to a three-piece type reel.

### Embodiment 1

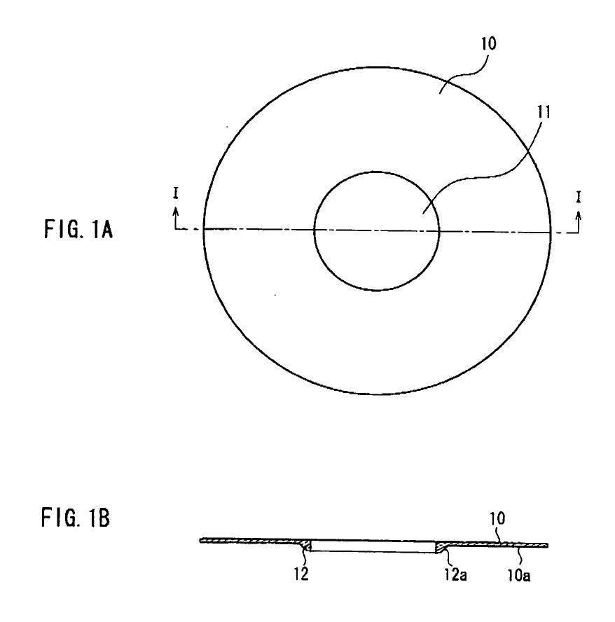

FIG. 1A is a plan view showing an example of a first flange used in a tape reel according to the present invention, and FIG. 1B is a sectional view taken along a line I-I in FIG. 1A As shown in FIGS. 1A and 1B, a first flange 10 is formed in a disk shape with an opening 11 in its central portion and has a joining rib 12 provided on its inner periphery. An outer peripheral surface 12a of the joining rib 12 is inclined 45° with respect to a principal plane 10a of the first flange 10 to the inner peripheral side.

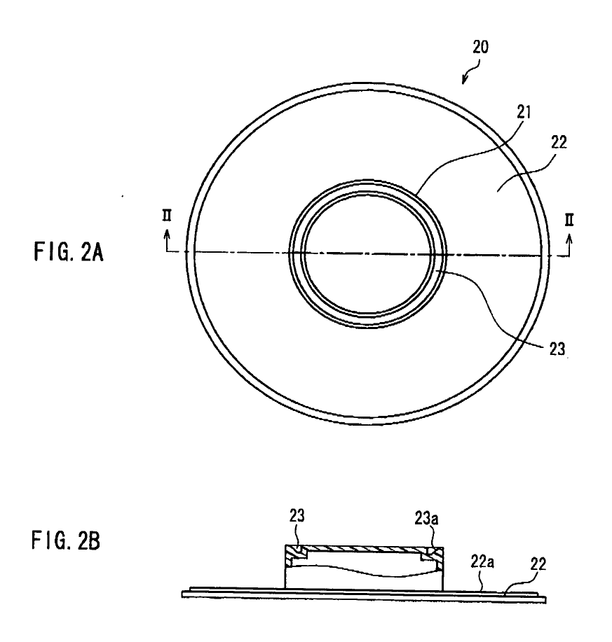

FIG. 2A is a plan view showing an example of a hub used in a tape reel according to the present invention, and FIG. 2B is a sectional view showing main portions of the hub, which is taken along a line II-II in FIG. 2A. As shown in FIGS. 2A and 2B, a hub 20 includes a cylindrical tape-winding portion 21 and a disk-shaped second flange 22, and the tape-winding portion 21 and the second flange 22 are formed integrally. The hub 20 has a joining groove 23 on an upper end of the tape-winding portion 21. An outer peripheral surface 23a of the joining groove 23 is inclined 45° with respect to a principal plane 22a of the second flange 22 to the outer peripheral side.

The first flange 10 and the hub 20 can be formed of an infrared absorbing material or an infrared transmitting material. It is to be noted, however, the first flange 10 and the hub 20 are formed of different materials at least in a joint portion that will be described later. For example, when the first flange 10 is formed of an infrared transmitting material, the hub 20 is formed of an infrared absorbing material.

As the infrared absorbing material, it is possible to use a resin or the like with an infrared transmittance of 10% or less. More specifically, it is possible to use polycarbonate, polystyrene, acrylonitrile-styrene resin, polyacetal, acrylonitrile-butadiene-styrene resin, or the like that has been colored with a coloring agent such as a pigment or a dye. As the coloring agent, it is possible to use, for example, a phthalocyanine compound, a polymethine compound, a cyanine compound, carbon black, or the like. The infrared transmittance can be controlled through the adjustment of the color tone of the resin etc. by increasing or decreasing the amount of the coloring agent. As the infrared transmitting material, it is possible to use a resin or the like with an infrared transmittance of 40% or more, and it is preferable to use a transparent resin or the like with an infrared transmittance of 90% or more. More specifically, polycarbonate, polystyrene, acrylonitrile-styrene resin, or the like that has been adjust so as to have an infrared transmittance of 40% or more can be used, regardless of whether it is colored or colorless.

The present embodiment is directed to the case where the entire first flange 10 is formed of transparent polycarbonate with an infrared transmittance of 90% or more and the entire hub 20 is formed of black polycarbonate with an infrared transmittance of 6% to 10%. Note here that the black polycarbonate is obtained by coloring polycarbonate with carbon black.

The surface roughness Rz of at least one of the outer peripheral surface 12a of the joining rib 12 and the outer peripheral surface 23a of the joining groove 23 is set to 3 to 40 μm. With this configuration, the joining strength between the first flange 10 and the hub 20 can be improved still further.

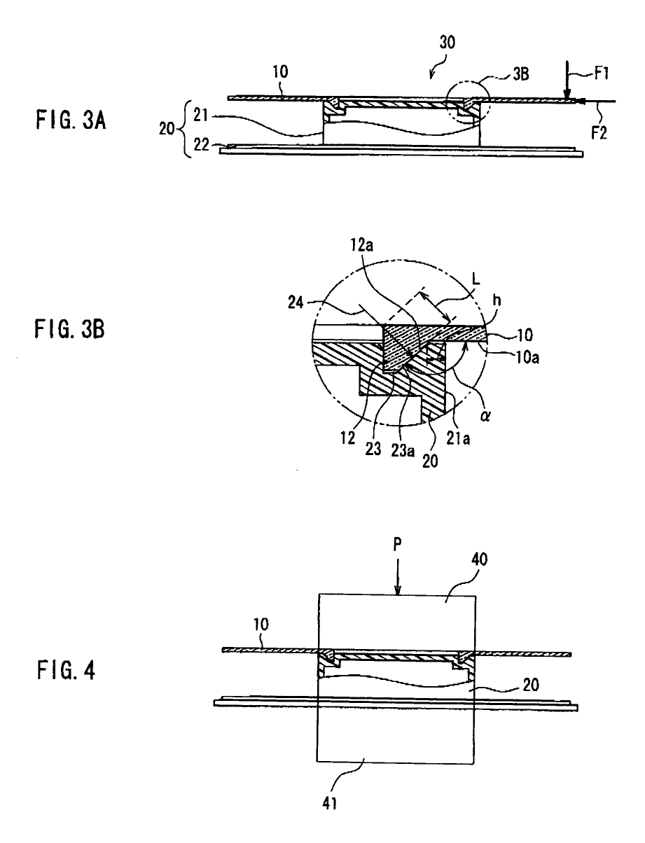

FIG. 3A is a sectional view showing main portions of an example of a tape reel according to the present invention. As shown in FIG. 3A, in a reel 30, the first flange 10 and the hub 20, which have been described with reference to FIGS. 1A and 2A, are joined to each other at a joint portion and the first flange 10 and the second flange 22 that is formed integrally with the tape-winding portion 21 extend in the radial direction from an outer periphery of the hub 20.

FIG. 3B is an enlarged view of the joint portion (the portion 3B) in FIG. 3A. As shown in FIG. 3B, the joining rib 12 of the first flange 10 is joined to the joining groove 23 of the hub 20 by laser welding that will be described later. That is, in the portion 3B, the outer peripheral surface 12a of the joining rib 12 and the outer peripheral surface 23a of the joining groove 23 are connected to each other by welding, thus forming the joint portion.

In the above-described joint portion, the outer peripheral surface 12a of the joining rib 12 and the outer peripheral surface 23a of the joining groove 23 are arranged so as to form inclined surfaces. Thus, even if an external force F1 and an external force F2 are applied to the outer peripheral portion of the first flange 10 as shown in FIG. 3A due to the dropping or the like of the reel 30, the external forces can be dispersed by the inclined surfaces (the outer peripheral surfaces 12a and 23a). Therefore, the impact resistance of the reel 30 can be improved. Moreover, when the outer peripheral surfaces 12a and 23a are inclined surfaces as described above, an angle α that the outer peripheral surfaces 12a and 23a form with the principal plane 10a of the first flange 10 on the outer peripheral side of the hub 20 can be made an obtuse angle. Thus, it is possible to improve the strength of the joint of the flange 10 where stresses are concentrated.

When the outer peripheral surfaces 12a and 23a are inclined surfaces as described above, there is a possibility that heat caused during the laser welding might be transferred to the tape-winding surface 21a. On this account, it is preferable that the shortest distance h between the joined surfaces (the outer peripheral surfaces 12a and 23a) and the tape-winding surface 21a of the hub 20 is set to be 0.5 mm or more. With this configuration, it is possible to suppress the transfer of the heat caused during the laser welding to the tape-winding surface 21a, thus preventing the thermal deformation of the tape-winding surface 21a.

Next, a method for manufacturing a tape reel according to the present embodiment will be described. In a method for manufacturing the reel 30 according to the present embodiment, first, the joining rib 12 of the first flange 10 is inserted into the joining groove 23 of the hub 20 as shown in FIGS. 3A and 3B, thereby engaging the outer peripheral surface 12a of the joining rib 12 and the outer peripheral surface 23a of the joining groove 23 with each other tightly. At this time before welding, the first flange 10 and the hub 20 are positioned by their surfaces to be joined (the outer peripheral surfaces 12a and 23a), which are formed as inclined surfaces, so that they are arranged at the positions for forming the final shape of the reel. Accordingly, it is possible to provide the reel having high shape accuracy after laser welding.

Next, as shown in FIG. 3B, the outer peripheral surface 12a is irradiated with a laser beam 24 that it incident thereon substantially perpendicularly from the first flange 10 side. The laser beam 24 passes through the first flange 10 formed of transparent polycarbonate as the infrared transmitting material and then is absorbed by the hub 20 formed of black polycarbonate as the infrared absorbing material, whereby heat is generated in the vicinity of the outer peripheral surface 23a. Thus, the outer peripheral surface 23a is melted, and the outer peripheral surface 12a is melted by this melting heat Then, after the irradiation with the laser beam 24 is stopped, the melted portions cool down naturally, whereby the outer peripheral surface 12a and the outer peripheral surface 23a are joined to each other instantaneously By the use of the laser beam 24, it becomes possible to control the irradiation range with pinpoint accuracy, so that there is no fear that portions other than the joint portion might be melted. Moreover, since the first flange 10 and the hub 20 are engaged with each other tightly at their outer peripheral surfaces 12a and 23a before welding, the first flange 10 does not move after the welding, so that the first flange 10 and the hub 20 can be joined to each other with high shape accuracy.

Used as the laser beam 24 is near-infrared radiation having a wavelength in the range from 700 to 1100 nm, which can be absorbed by resin materials easily. Furthermore, in FIG. 3B, the thickness L of the first flange 10 formed of the infrared transmitting material as measured in the laser beam irradiation direction is set to be 4 mm or less in order to improve the laser transmittance.

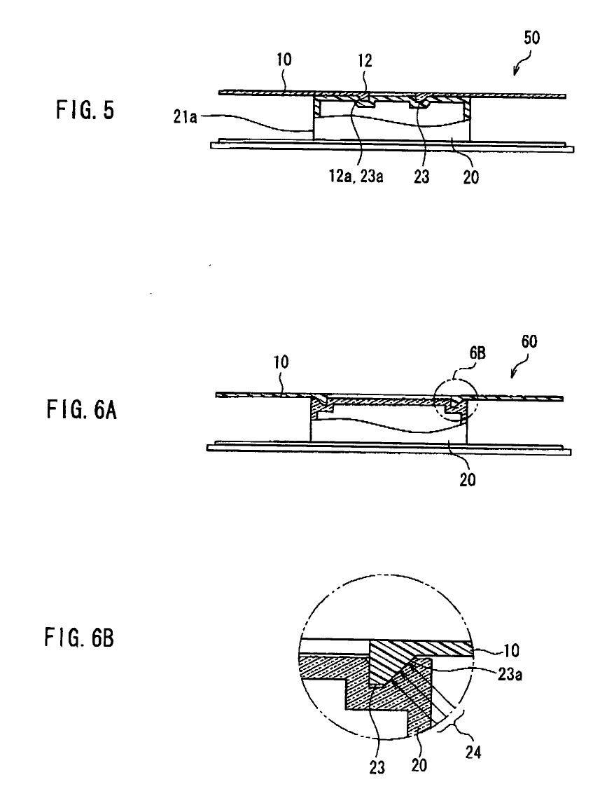

FIG. 4 is a sectional view showing main portions of a tape reel for illustrating another example of a method for manufacturing a tape reel according to the present invention. In FIG. 4, at the time of the above-described laser welding, a pressure P further is applied to the first flange 10 and the hub 20 by a pressure-applying member 40 within a range where the positional accuracy of the first flange 10 and the hub 20 is not deteriorated. This allows the joining strength of the first flange 10 and the hub 20 to be improved further. The pressure is applied in the state where the first flange 10 and the hub 20 are placed on a receiving jig 41. In order to perform the irradiation with the laser beam and the application of the pressure at the same time, the pressure-applying member 40 is formed of a laser transmitting material.

In the present embodiment, the two-piece type reel has been described as in the above It is to be noted that a three-piece type reel can be obtained by further welding a second flange to a hub in the same manner as in the present embodiment.

### Embodiment 2

FIG. 5 is a sectional view showing main portions of another example of a tape reel according to the present invention. As shown in FIG. 5, a reel 50 of the present embodiment has the same configuration as the reel of Embodiment 1 except that the outer peripheral surface 12a of the joining rib 12 and the outer peripheral surface 23a of the joining groove 23 are moved so as to be closer to the inner circumference of the reel than in Embodiment 1 and produces the same effect as the reel of Embodiment 1. Thus, the same components are given the same reference numerals and the description thereof has been omitted.

In the present embodiment, because outer peripheral surfaces 12a, 23a are arranged on the inner circumference side, it is possible to suppress the transfer of the heat caused during the laser welding to the tape-winding surface 21a more reliably, thus preventing the thermal deformation of the tape-winding surface 21a.

### Embodiment 3

FIG. 6A is a sectional view showing main portions of still another example of a tape reel according to the present invention, and FIG. 6B is an enlarged view of a joint portion (a portion 6B) in FIG. 6A. A reel 60 of the present embodiment has the same configuration as the reel 30 of Embodiment 1 except that the entire first flange 10 is formed of black polycarbonate with an infrared transmittance of 10% or less and the entire hub 20 is formed of transparent polycarbonate with an infrared transmittance of 90% or more and produces the same effect as the reel 30 of Embodiment 1. Thus, the same components are given the same reference numerals and the description thereof thus has been omitted.

The reel 60 according to the present embodiment can be manufactured by irradiating a surface 23a of a joining groove 23 with a laser beam 24 that it incident thereon substantially perpendicularly from a hub 20 side, as shown in FIG. 6B.

### Embodiment 4

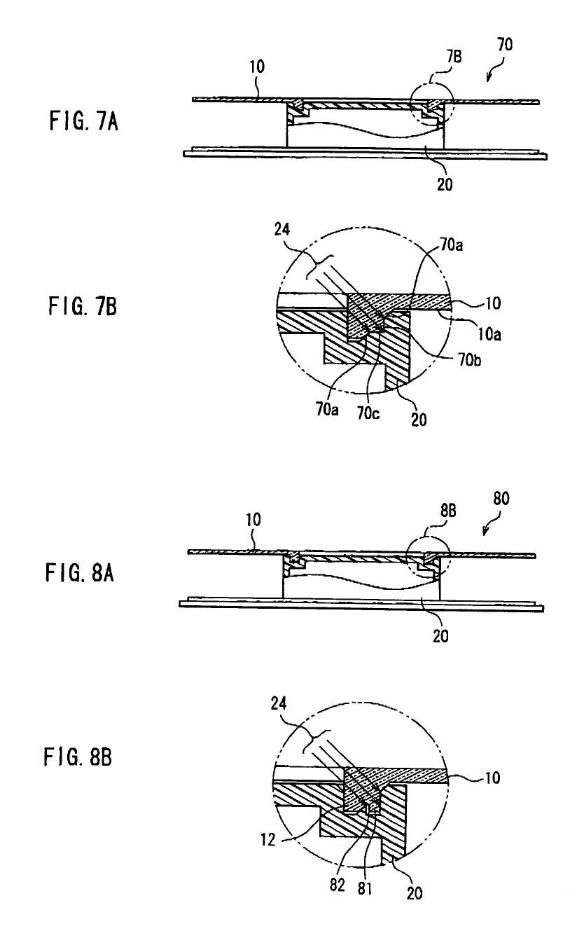

FIG. 7A is a sectional view showing main portions of still another example of a tape reel according to the present invention, and FIG. 7B is an enlarged view of a joint portion (a portion 7B) in FIG. 7A. A reel 70 of the present embodiment has the same configuration as the reel 30 of Embodiment 1 except that each of the joined surfaces at the joint portion is composed of portions 70a inclined with respect to the principal plane 10a of the first flange 10, a portion 70b perpendicular to the principal plane 10a of the first flange 10, and a portion 70c parallel to the principal plane 10a of the first flange 10 and produces the same effect as the reel 30 of Embodiment 1. Thus, the same components are given the same reference numerals and the description thereof has been omitted.

In the present embodiment, since each of the joined surfaces at the joint portion is composed of the portions 70a inclined with respect to the principal plane 10a of the first flange 10, the portion 70b perpendicular to the principal plane 10a of the first flange 10, and the portion 70c parallel to the principal plane 10a, the positioning accuracy of the first flange 10 and the hub 20 can be improved further. Besides, since the welded area increases, the joining strength can be improved further.

### Embodiment 5

FIG. 8A is a sectional view showing main portions of still another example of a tape reel according to the present invention, and FIG. 8B is an enlarged view of a joint portion (a portion 8B) in FIG. 8 A reel 80 of the present embodiment has the same configuration as the reel 30 of Embodiment 1 except that, in the joint portion, a projection 81 is formed on the joined surface of the first flange 10 and a recess 82 is formed on the joined surface of the hub 20 and produces the same effect as the reel 30 of Embodiment 1. Thus, the same components are given the same reference numerals and the description thereof has been omitted.

In the present embodiment, since the projection 81 is formed on the joined surface at the joint portion, the positioning accuracy of the first flange 10 in the radial direction can be improved further, and the welded area increases to allow the jog strength to be improved further.

Although the projection 81 is provided on the first flange 10 side and the recess 82 is provided on the hub 20 side in the present embodiment, the projection 81 and the recess 82 may be provided on the inverse sides, respectively.

### Embodiment 6

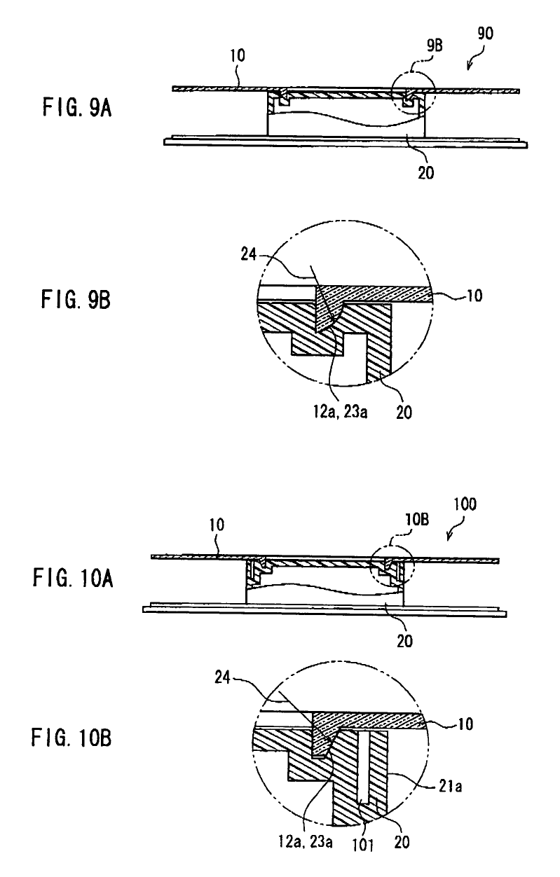

FIG. 9A is a sectional view showing main portions of still another example of a tape reel according to the present invention, and FIG. 9B is an enlarged view of a joint portion (a portion 9B) in FIG. 9A. A tape reel 90 of the present embodiment has the same configuration as the reel 30 of Embodiment 1 except that the joined surfaces (the outer peripheral surfaces 12a and 23a) at the joint portion are formed of curved surfaces and produces the same effect as the reel 30 of Embodiment 1. Thus, the same components are even the same reference numerals and the description thereof has been omitted.

In the present embodiment, since the joined surfaces at the joint portion are formed of curved surfaces, the welded area increases to allow the joining strength to be improved further.

### Embodiment 7

FIG. 10A is a sectional view showing main portions of still another example of a tape reel according to the present invention, and FIG. 10B is an enlarged view of a joint portion (a portion 10B) in FIG. 10A. A reel 100 of the present embodiment has the same configuration as the reel 30 of Embodiment 1 except that a recess groove 101 is formed between the joined surfaces (the outer peripheral surfaces 12a and 23a) at the joint portion and the tape-winding surface 21a of the hub 20 and produces the same effect as the reel of Embodiment 1. Thus, the same components are given the same reference numerals and the description thereof has been omitted.

In the present embodiment, since the recess groove 101 is formed between the joined surfaces at the joint portion and the tape-winding surface 21a, it is possible to suppress the transfer of the heat caused during the laser welding to a tape-winding surface 21a more reliably and the influence of heat expansion/shrinkage during the laser welding can be absorbed. Thus, the shape accuracy of the tape-winding surface 21a can be maintained.

### Embodiment 8

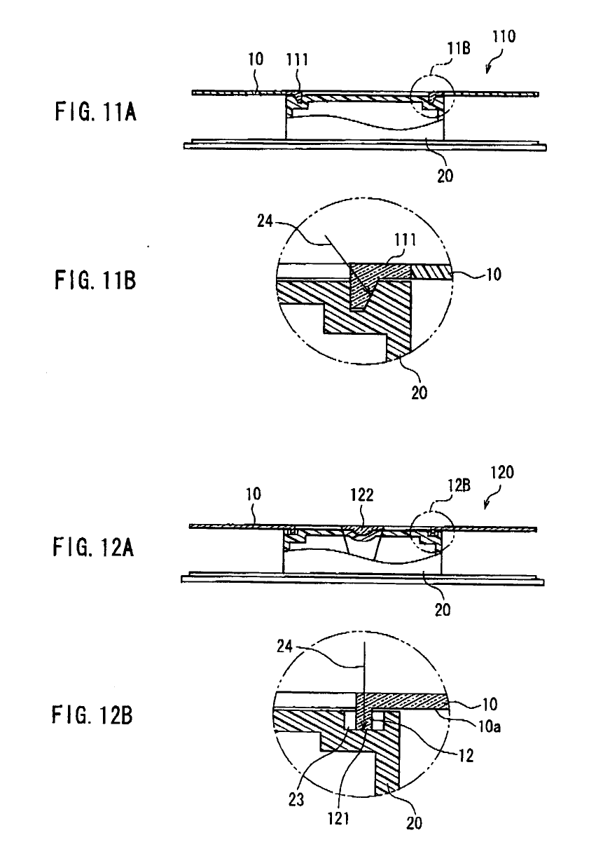

FIG. 11A is a sectional view showing main portions of still another example of a tape reel according to the present invention, and FIG. 11B is an enlarged view of a joint portion (a portion 11B)in FIG. 11A A reel 110 of the present embodiment has the same configuration as the reel 30 of Embodiment 1 except that only a portion 111 of the first flange 10 to be joined is formed of transparent polycarbonate with an infrared transmittance of 90% or more and the remaining portion is formed of black polycarbonate with an infrared transmittance of 10% or less and produces the same effect as the reel 30 of Embodiment 1. Thus, the same components are given the same reference numerals and the description thereof has been omitted.

In the present embodiment, since the portion 111 to be joined is formed of an infrared transmitting material, laser welding can be performed in the same manner as in Embodiment 1.

### Embodiment 9

FIG. 12A is a sectional view showing main portions of still another example of a tape reel according to the present invention, and FIG. 12B is an enlarged view of a joint portion (a portion 12B) in FIG. 12A. A reel 120 of the present embodiment has the same configuration as the reel 30 of Embodiment 1 except the first flange 10 and the hub 20 are formed so that their joined surfaces 121 are horizontal to the principal plane 10a of the first flange 10 and a positioning projection 122 further is provided. Thus, the same components are given the same reference numerals and the description thereof has been omitted.

In the present embodiment, since the joined surfaces 121 are formed so as to extend horizontally, the positioning accuracy of the first flange 10 and the hub 20 is deteriorated slightly as compared with Embodiment 1 where the joined surfaces (the outer peripheral surfaces 12a, 23a) are formed so as to be inclined surfaces. Thus, the present embodiment is applicable to the case where accuracy tolerance in the radial direction and the thickness direction of the reel is high.

The tape reel 120 according to the present embodiment can be manufactured by irradiating the principal plane 10a of the first flange 10 with a laser beam 24 that is incident thereon substantially perpendicularly as shown in FIG. 12B.

### Embodiment 10

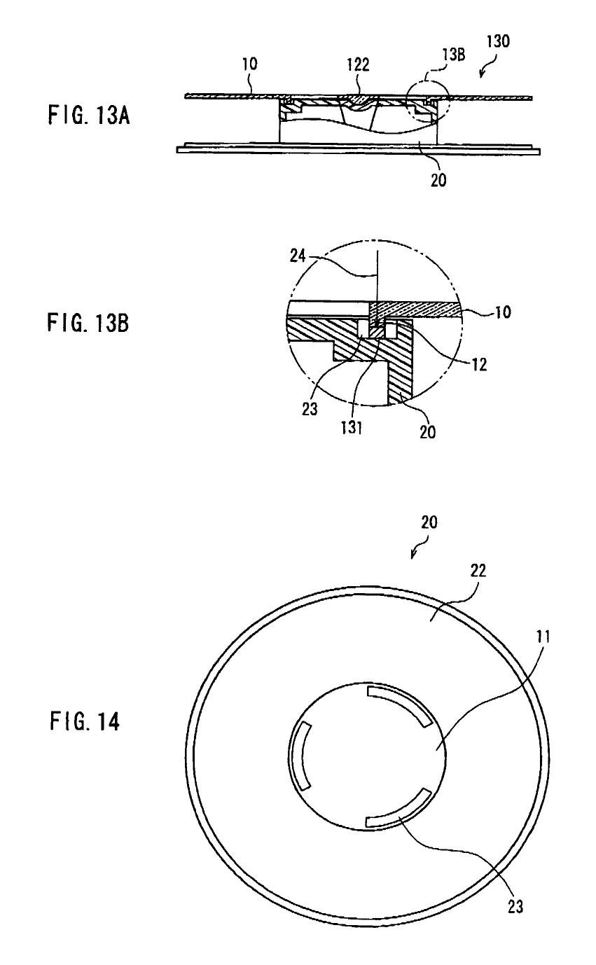

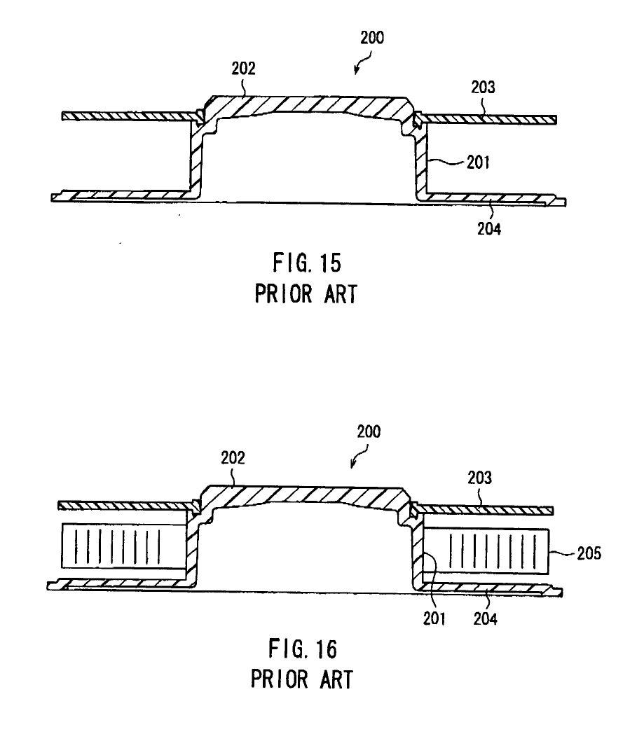

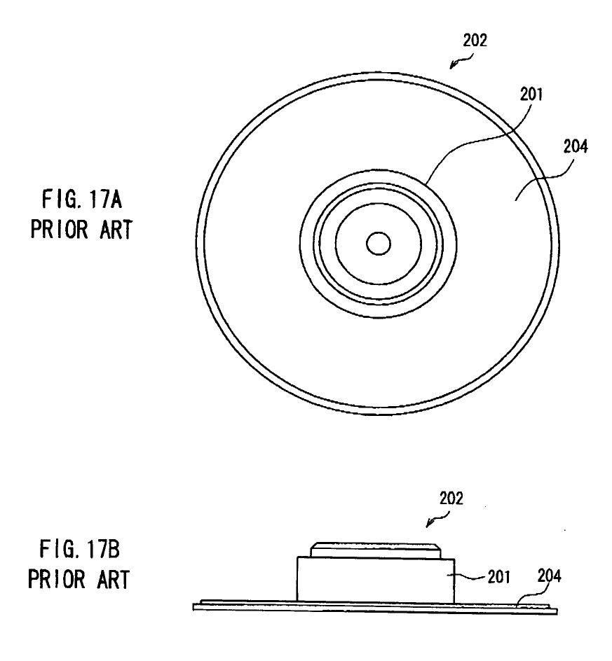

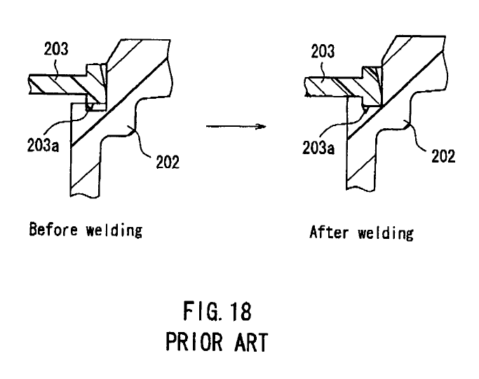

FIG. 13A is a sectional view showing main portions of still another example of a tape reel according to the present invention, and FIG. 13B is an enlarged view of a joint portion (a portion 13B) in FIG. 13A. A reel 130 of the present embodiment has the same configuration as the tape reel 120 of Embodiment 9 except that a high-efficiency infrared absorbing material 131 formed of black polycarbonate with an infrared transmittance of 5% or less is arranged between the joining rib 12 and the joining groove 23 and produces the same effect as the tape reel 120 of Embodiment 9. Thus, the same components are given the same reference numerals and the description thereof has been omitted.

The high-efficiency infrared absorbing material 131 can be prepared by increasing the added amount of carbon black as a coloring agent. Although the high-efficiency infrared absorbing material 131 can be arranged by, for example, applying or placing the infrared absorbing material that is in the form of liquid or sheet onto the joining groove 23, it may be formed integrally with the outer surface of the joining rib 12 or the joining groove 23. Furthermore, the high-efficiency infrared absorbing material 131 may be mixed with an adhesive. This improves the stability of the first flange 10 and the hub 20 at the time of their assembly before welding.

In the present embodiment, since the high-efficiency infrared absorbing material 131 is used, the heat generation efficiency increases so that the irradiation time or the irradiation intensity of a laser beam 24 can be decreased. Thus, it is possible to alleviate the influence of the laser beam 24 on other portions.

### Embodiment 11

FIG. 14 is a plan view showing a hub used in still another example of a tape reel according to the present invention. A hub 20 used in the present embodiment has the same configuration as the hub 20 used in Embodiment 9 except that the joining groove 23 is formed discontinuously. Thus, the same components are given the same reference numerals and the description thereof has been omitted.

In Embodiment 9 described above, it is necessary to maintain the flatness of the joined surfaces 121 that are formed so as to extend in a wide range (i.e., the entire periphery). When the flatness of the joined surfaces 121 becomes higher, the adhesion between the joined surfaces in the joint portion is enhanced, resulting in improved joining strength. In the present embodiment, the flatness can be maintained relatively easily because the range where the flatness should be maintained may be narrower.

As specifically described above, since the tape reel according to the present invention can achieve high shape accuracy, the rotational accuracy of the reel also is improved, which allows the running stability of the tape to be improved. Consequently, the tape reel according to the present invention can contribute to higher performance of tape cartridges.

Moreover, by the method for manufacturing a tape reel according to the present invention, the above-described tape reel of the present invention can be manufactured efficiently with simple facilities. Thus, the method according to the present invention is extremely valuable from an industrial viewpoint.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A tape reel comprising:
a disk-shaped first flange;
a cylindrical hub; and
a disk-shaped second flange,
the first flange and the second flange extending in a radial direction from an outer periphery of the hub,
wherein at least one flange selected from the first flange and the second flange is joined to the hub at a joint portion,
at least in the joint portion, the flange and the hub are formed of different materials, and
the different materials are an infrared absorbing material and an infrared transmitting material.

2. The tape reel according to claim 1, wherein the flange and the hub are joined by laser welding.

3. The tape reel according to claim 1, wherein the infrared absorbing material has an infrared transmittance of 10% or less, and the infrared transmitting material has an infrared transmittance of 40% or more.

4. The tape reel according to claim 1, wherein, in the joint portion, at least one of a joined surface of the flange and a joined surface of the hub has a surface roughness Rz of 3 to 40 μm.

5. The tape reel according to claim 1, wherein a shortest distance between joined surfaces in the joint portion and a tape-winding surface of the hub is 0.5 mm or more.

6. The tape reel according to claim 1, wherein the joined surfaces in the joint portion are inclined with respect to a principal plane of the flange to an inner peripheral side.

7. The tape reel according to claim 6, wherein an angle that the joined surfaces in the joint portion form with the principal plane of the flange on the inner peripheral side is 45°.

8. The tape reel according to claim 1, wherein each of the joined surfaces in the joint portion includes a portion inclined with respect to the principal plane of the flange, a portion perpendicular to the principal plane of the flange, and a portion parallel to the principal plane of the flange.

9. The tape reel according to claim 1, wherein, in the joint portion, a projection is formed on at least one of a joined surface of the flange and a joined surface of the hub.

10. The tape reel according to claim 4, wherein, in the joint portion, a projection is formed on at least one of the joined surface of the flange and the joined surface of the hub.

11. The tape reel according to claim 1, wherein joined surfaces in the joint portion are formed of curved surfaces.

12. The tape reel according to claim 4, wherein the joined surfaces in the joint portion are formed of curved surfaces.

13. The tape reel according to claim 5, wherein the joined surfaces in the joint portion are formed of curved surfaces.

14. The tape reel according to claim 1, wherein a space is formed between joined surfaces in the joint portion and a tape-winding surface of the hub.

15. The tape reel according to claim 5, wherein a space is formed between the joined surfaces in the joint portion and the tape-winding surface of the hub.

16. The tape reel according to claim 1, wherein the first flange has an opening in its central portion and a joining rib on its inner periphery,
the hub has a joining groove,
the joining rib is joined to the joining groove by laser welding, and
the second flange is formed integrally with the hub.

17. The tape reel according to claim 16, wherein an outer peripheral surface of the joining rib is inclined with respect to a principal plane of the first flange to an inner peripheral side.

18. A method for manufacturing a tape reel,
the tape reel comprising:
a disk-shaped first flange;
a cylindrical hub; and
a disk-shaped second flange,
the first flange and the second flange extending in a radial direction from an outer periphery of the hub,
wherein at least one flange selected from the first flange and the second flange is joined to the hub at a joint portion,
at least in the joint portion, the flange and the hub are formed of different materials, and
the different materials are an infrared absorbing material and an infrared transmitting material,
the method comprising the step of;
joining the at least one flange selected from the first flange and the second flange to the hub by laser welding.

19. The method according to claim 18, wherein a laser beam used for the laser welding is near infrared radiation having a wavelength in a range from 700 to 1100 nm.

20. The tape reel according to claim 18, wherein a thickness of the infrared transmitting material in a laser beam irradiation direction is 4 mm or less.
